(19) United States
(12) Patent Application Publication
(10) Pub. No.: US 2013/0110300 A1
(43) Pub. Date: May 2, 2013

(54) HIERARCHICAL ARCHITECTURE FOR OPTIMIZING HYBRID ENERGY STORAGE SYSTEM PERFORMANCE

(71) Applicant: LOCKHEED MARTIN CORPORATION, Bethesda, MD (US)

(72) Inventor: Steven L. SINSABAUGH, Uniontown, OH (US)

(73) Assignee: LOCKHEED MARTIN CORPORATION, Bethesda, MD (US)

(21) Appl. No.: 13/648,403

(22) Filed: Oct. 10, 2012

Related U.S. Application Data
(60) Provisional application No. 61/551,565, filed on Oct. 26, 2011.

(51) Int. Cl. G05F 5/00

(52) U.S. Cl. 700/291; 700/286

(57) ABSTRACT

A hierarchical architecture for optimizing hybrid energy storage system performance includes a physics layer which provides at least two energy storage sources, wherein each source generates a source signal. The architecture further includes a technology control layer that receives the source signals into a corresponding controller, and where each controller has a parameter table. A technology control interface signal is generated by the controller and the parameter table working together. A storage network layer receives the technology control interface signals into a storage system optimization controller to manage operation of the different energy sources.

### CROSS-REFERENCE TO RELATED APPLICATIONS

This application claims priority of U.S. Provisional Application Ser. No. 61/551,565 filed Oct. 26, 2011, which is incorporated herein by reference.

### TECHNICAL FIELD

Generally, the present invention is directed to energy storage systems. Specifically, the present invention is related to interrelating disparate energy storage technologies so that they can be used together to supply energy needs.

### BACKGROUND ART

Hybrid energy storage systems, which typically consist of two or more electrical energy storage technologies, have been proposed for a wide range of applications from electric vehicles to electrical grid storage. While there are some first-order cost benefits to these hybrid systems, such as common inverters and the like, none are known to provide an optimized control structure that obtains the full benefits of the hybridization.

As will be appreciated by skilled artisans, energy storage systems are used in a wide array of applications. These can range from batteries in cell phones to data center back-up power systems. Energy storage systems are also used for other applications ranging from electrical grid storage to support renewal energy, to electric vehicles. A wide range of electrical energy storage technologies such as flywheels; flow batteries; super capacitors; lithium-ion batteries and so on can be employed. A hybrid energy storage system consists of two or more electrical energy storage components, typically with different technologies. For example, some systems combine the use of flow batteries and fly wheels, while others may combine lithium-ion batteries and super capacitors. These different technologies have different characteristics, such as charge and discharge rates, capacities, cycle life and so on.

One existing solution is a hybrid storage system where a flow battery and bank of lithium-ion batteries are used together. Such systems provide cost savings which accrue from using common power electronics such as switching and inverters, but such a system control has to be custom-designed and the system is not designed for real-time optimization. In other words, the two disparate systems—flow batteries and lithium batteries—cannot be interchanged with one another easily and in a manner which allows for quick switch-over between technologies.

Therefore there is a need for a system which provides for a hierarchical architecture to a hybrid energy storage system. Such an architecture should be adaptable for hybrid applications as wide ranging as grid storage to electric vehicles. Ideally, such a system should be able to adapt to the addition and deletion of storage units automatically and be able to recognize new types of energy storage devices and interact with them with minimal downtime to the overall system. Such an architecture should be able to provide for segregation of layers of control, separating technology-specific controls from higher-order storage optimization controls. Indeed, such an architecture should be able to include establishment of a generic set of parameters that can be used to describe a wide range of energy storage technologies, with sufficient fidelity to enable a higher order control system to manage and optimize energy flows to and from each storage unit, and potentially between a wide variety of storage units. These generic parameters may include economic data that described the impact of various actions, such as charge and discharge, charge and discharge rates, which may impact the overall lifetime of the particular storage system as well as the economic impact of internal losses and inefficiencies.

### SUMMARY OF THE INVENTION

In light of the foregoing, it is a first aspect of the present invention to provide a hierarchical architecture for optimizing hybrid energy storage system performance.

It is another aspect of the present invention to provide a hierarchical architecture for optimizing hybrid energy storage system performance, the architecture comprising a physics layer providing at least two energy sources, wherein each energy source generates a source signal, a technology control layer receiving the source signals into a corresponding controller, each controller having a parameter table associated therewith, wherein the controller and the table together generate technology control interface signals, and a storage network layer receiving the technology control interface signals into a storage system optimization controller to manage operation of the different energy sources.

### BRIEF DESCRIPTION OF THE DRAWINGS

These and other features and advantages of the present invention will become better understood with regard to the following description, appended claims, and accompanying drawings wherein:

FIG. 1 is a schematic diagram of a hierarchical architecture according to the concepts of the present invention.

### BEST MODE FOR CARRYING OUT THE INVENTION

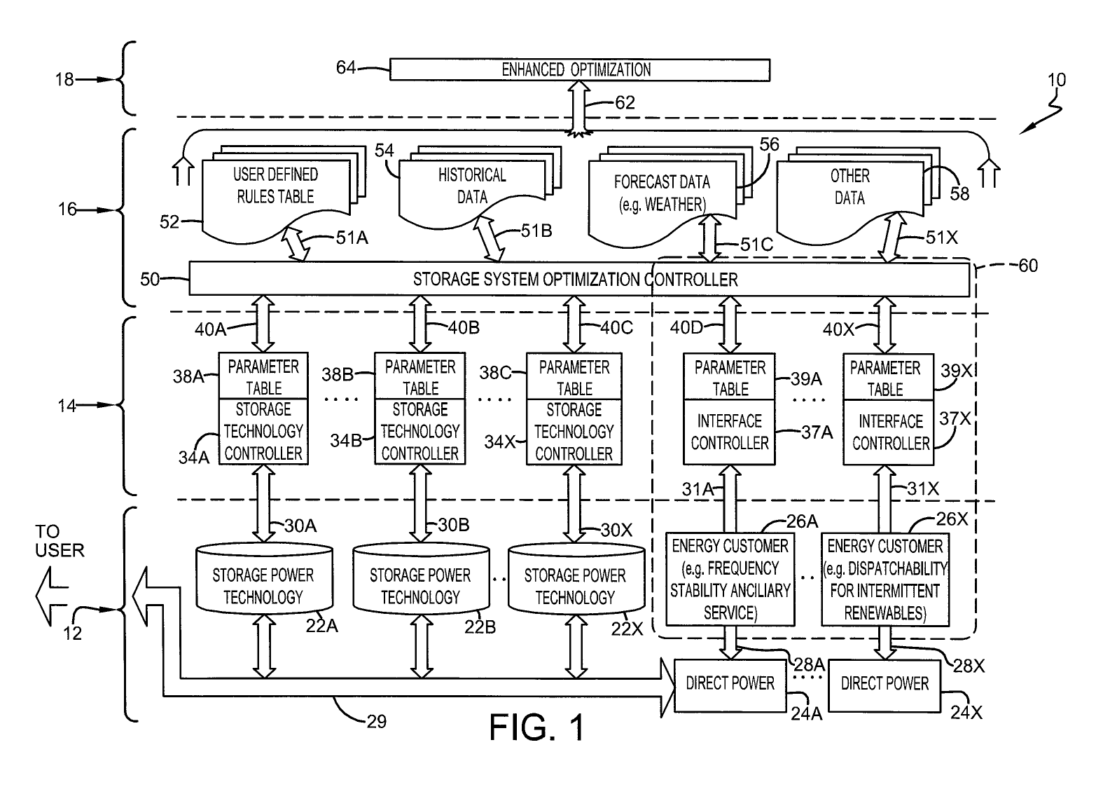

Referring now to FIG. 1, it can be seen that a hierarchical architecture for optimizing hybrid energy storage system performance is designated generally by the numeral 10. Generally, the architecture 10 utilizes several layers that allow for different energy generation technologies to be associated with one another so as to deliver electrical power to various customers. As such, the architecture provides for the management of energy storage systems. The architecture includes several layers and generally it provides a physics layer 12 which underlies and communicates with a technology control layer 14 which, in turn, underlies and communicates with a storage network layer 16. Optionally, an applications layer 18 may be utilized for communication or interrelationship with the storage network layer 16. As will become apparent as the description proceeds, links are provided between adjacent layers, but no direct links are provided to layers that are not adjacent to one another. For example, layer 14 is directly linked to layers 12 and 16, but layer 12 is not directly linked to layer 16.

The physics layer 12 comprises the actual core storage power technology and may be embodied for any number of storage power technology sources 22A, 22B, and so on. In other words, any number of sources, any type of source and any combination of sources may constitute the physics layer 12. Each storage power technology source 22 may be a battery, a flow battery, a capacitor bank, a bank of flywheels and so on. Each of the sources 22 may have an individual controller in the control layer 14 which performs the technology-specific low level control functions. Specifically, the technology control layer 14 may comprise a plurality of storage technology controllers 34A-34X wherein each technology controller is associated with a particular storage power technology 22.

The physics layer 12 may also include a direct power source 24 such as from the mains power grid 24A or directly from a power facility 24X. Each of these direct power sources 24 supply energy to any number of customers 26A and 26X respectively. Skilled artisans will appreciate that a requested demand 28 from the customer 26 is directed to the power source 24 which supplies the power level as needed by demand and/or expected demand. In any event, the energy customer 26 supplies systems and operational information about the energy to the technology control layer 14 as appropriate. The customer 26 supplies information to the technology control layer 14 depending on the specific ‘customer.’ As will be discussed in further detail, an optimization controller 50 in the storage network layer 16 collects the information on availability of grid energy (that the controller 60 may decide to have supplied to one or more storage units), the need for grid energy (inverse situation) or upcoming market opportunities (e.g. bidding on supplying frequency stability or other ancillary services). Indeed, the actual transfer of power generated or stored by devices in the physics layer 12 is envisioned to be handled by those devices with instructions or commands received from or through the various other layers in the architecture. Accordingly, in most embodiments, the energy generated and/or stored by the storage power sources 22 and/or the power sources 24 is sent and received along a transmission system 29. End users are connected to the transmission system 29 to receive the stored or generated power. In some embodiments, the direct power sources 24 may generate electrical energy for storage in any one, or any combination of, the storage power sources 22. The requests for demand/load information are transmitted through the respective interface controllers 37 on the technology control layer 14. Data typically includes things like nowcast or forecast load needs and pricing structures, availability of grid power for storage in one of the storage systems with costing information, and the like.

The storage technologies 22 supply physics layer signals and controls or source signals 30 to the storage technology controllers 34 while any number of energy customers 26A-26X provide their appropriate corresponding source signals 31A, 31X to an appropriate interface controller 37A and 37X respectively. As indicated in the drawing, use of capital letter suffixes such as A, B and X represent a specific line of control which is supplied to the next adjacent layer. As such, any number of devices and combination thereof may be utilized in a particular layer and they correspond to the appropriate next level component which has a like suffix. For example, storage technology device 22A supplies signals and controls 30A to storage technology controller 34A. Likewise, energy customer 26x supplies a source signal 31x to interface controller 37x.

In the technology control layer 14 it will be appreciated that parameter tables 38 and 39 are associated with each corresponding storage technology controller 34 and interface controller 37. As such, a parameter table 38A is associated with a corresponding interface controller 36A. Likewise, a parameter table 39 is associated with a corresponding interface controller 37. As skilled artisans will appreciate, different storage and generation technologies utilize different characteristics. Regardless, a common set of parameters that fundamentally define the characteristics and current status of each individual energy storage technology device 22 and/or direct power source 24 is believed to be obtainable. Such characteristics include, but are not limited to, total energy capacity, current state of charge, maximum charging rate, maximum discharge rate, internal energy losses and impact of charge states and rates on the lifetime of the specific unit. Some of these characteristics can be structured as functions of system lifetime. An exemplary parameter table 38 provided in the technology control layer 14 allows for any number of parameters to be utilized, and these are defined as follows:

CAP—Total capacity in joules. This will be a function of lifetime and expected changes as the system is charged and discharged.

SOC—State of charge (joules).

MIR—Maximum inflow rate (joules/second). This would be a function of the state of charge and may also include a temperature factor which would need to be added to the table.

MOR—Maximum outflow rate (joules/second).

IFL—Inflow loss (joules/joules). This would model internal impedances that effectively waste energy and would likely be a function of SOC, flowrate and possibly lifetime.

OFL—Outflow loss (joules/joule).

CCL—Calendar capacity loss (joule/day). This parameter relates to how the CAP decreases as a function of calendar time. For example, it is noted that in some technologies, such as lithium batteries, it may also represent losses in anolyte and catholyte purity in flow battery systems. In some cases this parameter may be resettable. Units may have to be structured more as percentage/day and the same will apply to other variables such as CSL below.

CSL—Calendar storage loss (joules/day). This parameter represents two losses and may have to be broken into other parameters. One loss is due to parasitics such as balance-of-plant lodes in flow batteries; frictional losses in flywheels and other losses encountered in the various storage technologies. A second source of loss may be the chemical loss in batteries.

CLI—Capacity loss on inflow (joules/joule). Losses in CAP as a function of charging. In most cases this will also be a function of SOC and inflow rate. For example, lithium-ion battery lifetime (in terms of capacity) is impacted by faster charging and discharging as well as deeper charge and discharge.

CLO—Capacity loss on outflow.

Based on experience with flow batteries, regular batteries, flywheels and other storage technologies, it will be appreciated that other parameters could be developed for particular storage technologies.

Each technology interface controller 34/37 and associated storage technology device 22 or customer 26 is believed to have different characteristics stored in the parameter table but wherein these characteristics are harmonized in a useable fashion. It is believed that the parameter tables would utilize a common protocol with set definitions. Some of the parameters will likely be effectively fixed, while others, such as current state of charge, would be updated as appropriate by the associated storage technology controller 34 or interface controller 37. Some parameters will likely be scalar, while others could be in the format of arrays or matrices as required. For example, energy loss for each joule of charging may be dependent on the state of charge. Structuring of the parameter table definitions is broad enough to cover a full range of storage options and to allow for modeling of them in a reasonable fashion.

Linkage between the technology control layer 14 and the storage network layer 16 is accomplished by utilization of the technology control interface signals 40. As noted previously, the technology control signals 40 are associated with each specific storage technology controller 34 or interface controller 37 and associated parameter table with the appropriate letter suffix. A storage system optimization controller 50 maintained by the storage network layer 16 receives the control signals 40. The layer 16 utilizes the characteristics provided in the parameter tables so as to provide for optimization. This system allows for managing of the “put and take” of each individual unit of energy, such as in joules and optimizes this individual unit of energy in terms of user-defined rules such as provided in the rules table 52. In other words, the controller 50 determines which storage power source 22 has excess storage capacity and/or which power source 24 is generating temporarily unneeded power. The controller can then, for example, coordinate operation of those devices and others for peak operating efficiency. A rules table 52, which is provided in the storage network layer 16 and linked to the controller by signals 51 A, defines various desired goals of the user, such as the type of optimization and various other items such as preventative maintenance cycles, such as when a unit will be taken off-line for servicing and so on. For an electrical grid application, the rules provided by the table 52 may focus on maximizing economic returns with various time horizons (minutes/hours/days/months), minimizing depreciations costs, etc. Skilled artisans will appreciate that the functioning of the user defined rules table 52, with the ability to interact with standardized parameter tables associated with a variety of storage technologies and energy customers, enables the controller 50 to provide market-like functionality to maximize the economic returns for the owner. In other words, as experience is gained with operation of the various storage technologies 22 and how effectively and efficiently they can work with the transmission system, the rules table can implement these characteristics to provide stability to the power grid in an efficient and economic manner. Also included in the storage network layer 16 may be historical data 54 and forecast data 56. Both of these are linked by the appropriate signals 51B and 51C as appropriate. Skilled artisans will appreciate that other data 58 may also be utilized by the storage system optimization controller 50 via the signals 51X communicated therebetween.

As an example, a node 60 that represents a frequency stability market may be utilized. The market may have maximum charge rates and maximum discharge rates and, as such, will have economic value tied to those rates. The total energy capacity may be defined as infinite and, as such, the technology control layer 14 could be updated regularly on the market price representing 15 minute auctioning or however the market is run to purchase such energy units in a predetermined time range. From this example it can be seen that a major role for the storage network layer 16 is to optimize the energy flow. The layer 16 looks to all of the nodes provided in the technology control layer, such as the storage units and the various customers or markets, and move those joules of energy about to meet the goals outlined in the rules table 52. If no forecast or historical data is available, the system will tend to just level things out in real time to achieve maximum economic value minute-by-minute, or by minimizing energy loss, wherein some of the nodes lose energy just in a standard operating state, or minimizing storage system depreciation or various combinations thereof. By inclusion of the historical data 54 or the forecast data 56 or other data 58, the controller 50 can utilize some sort of predictor function to enable looking ahead some interval in time in an attempt to optimize performance, again following the goals set out in the rules table 52. These functions are performed by the optimization controller 50 so as to determine needs and the most efficient way for providing for those needs.

In an alternative embodiment, it will be appreciated that the applications layer 18 may utilize an enhanced optimization controller 64, which collectively communicates with all of the data tables provided and also to the optimization controller 50. This would allow for more sophisticated optimization approaches to consider other environmental or user-based needs.

The advantages of the present invention are readily apparent. The architecture 10 provides for a standard layer approach which allows for separation of specifics of dealing with individual technologies from the optimization control. A standard parameter interface is provided which provides for a standard set of parameters that model any type of energy storage or energy customer. New technologies can be readily interfaced using the standard parameter table thereby avoiding costly changes to the hybrid energy storage overall controller system. Still another advantage is the ability to treat energy storage technologies and customers identically. Both can be modeled with the same set of parameters, thereby simplifying the overall architecture system. As such, it will be appreciated that the controller 50 is simply optimizing the flow of information between the specific units. The architecture 10 also provides for the ability to allow the controller to optimize energy flow for various user-defined economicals, such as maximizing near-term costs, minimizing longer-term risks, and so on. Indeed, the architecture 10 allows for optimization wherein the optimizing of the performance of the overall hybrid energy storage system meets user goals which are typically economic in nature and based on a standardized set of parameters describing the individual energy storage components.

The optimization can be further enhanced with the use of historical data and forecast data when available. Still another benefit is to simplify the development of hybrid energy storage systems by having a common architecture to make the combination of various storage technologies easier to integrate. This is attained by utilization of the layer definition wherein the technology controller layer controls specific individual storage technologies and utilizes a standard interface between the technology control and the storage network layer. This is done by utilizing a set of parameters that describe the performance of each storage system. Still another benefit is the ability to modify the technology control layer for individual storage components without having to alter the storage network layer controls. For instance, a lithium-ion storage system could require modification of its internal charge/discharge characteristics, which would require modifications to the battery controller, which is disposed in the technology control layer. This would not require any changes to the storage network layer control, since any modifications relevant at that level would simply be made within the parameter table in the technology control layer 14 that is accessed by the storage network layer 16.

The economics of the hybrid system are intertwined with the characteristics of each individual energy storage technology. One benefit of a proposed hybrid energy storage system would be the ability to provide energy to satisfy multiple desired goals. For example, a fly wheel and a flow battery hybrid storage system would be able to provide frequency stability due to the characteristics of the fly wheel, and dispatchable energy from an intermittent renewal source such as the flow battery. Yet another benefit for the proposed system would be to provide multiple revenue streams, thereby increasing economic feasibility of the overall system. It is also believed that such a system would be desirable in that the hybrid energy control system may be applicable to a wide range of storage technologies and applications, rather than having to create such a control system from scratch.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A hierarchical architecture for optimizing hybrid energy storage system performance, the architecture comprising:
a physics layer providing at least two energy sources, wherein each energy source generates a source signal;
a technology control layer receiving said source signals into a corresponding controller, each said controller having a parameter table associated therewith, wherein said controller and said table together generate technology control interface signals; and
a storage network layer receiving said technology control interface signals into a storage system optimization controller to manage operation of said different energy sources.

2. The architecture according to claim 1, wherein said storage network layer comprises:
a rules table linked to said storage system optimization controller, said rules table determining maximum outputs based on an operational status of said at least two energy sources.

3. The architecture according to claim 2, wherein said storage network layer further comprises:
a historical database linked to said storage system optimization controller; and
a forecast database linked to said storage system optimization controller.

4. The architecture according to claim 1, wherein said technology control layer further comprises:
a parameter table associated with each said controller, wherein said parameter table provides common definitions for characteristics of all said energy sources.

5. The architecture according to claim 1, wherein said energy sources comprise any combination of at least one storage power source or at least one direct power source.

6. The architecture according to claim 5, further comprising:
a transmission system linking said energy sources to one another.

7. The architecture according to claim 6, wherein said storage power sources are selected from the group consisting of a battery, a flow battery, a capacitor bank and a bank of flywheels.

8. The architecture according to claim 6, wherein said technology control layer comprises a storage technology controller associated with each said storage power source and an interface controller associated with each said direct power source.

9. The architecture according to claim 8, further comprising:
a parameter table associated with each said controller, wherein each said parameter table provides common definitions for characteristics of all said energy sources.

10. The architecture according to claim 9, wherein said storage network layer comprises:
a rules table linked to said storage system optimization controller, said rules table determining maximum outputs based on an operational status of said at least two energy sources.

11. The architecture according to claim 10, wherein said storage network layer further comprises:
a historical database linked to said storage system optimization controller; and
a forecast database linked to said storage system optimization controller.

12. The architecture according to claim 11, further comprising:
an applications layer in communication with said storage network layer, said applications layer comprising an enhanced optimization controller linked to at least one of said rules table, said historical database and said forecast database.
